(19) United States
(12) Patent Application Publication
(10) Pub. No.: US 2013/0288155 A1
(43) Pub. Date: Oct. 31, 2013

(54) SUPPORT FOR ELECTRODE CATALYST AND METHOD OF MANUFACTURING THE SAME, ELECTRODE CATALYST AND FUEL CELL

(71) Applicant: SAMSUNG SDI CO., LTD., Yongin-si (KR)

(72) Inventors: Jun-Young KIM, Yongin-si (KR); Sung-Chul LEE, Yongin-si (KR); Myoung-Ki MIN, Yongin-si (KR); Yong-Bum PARK, Yongin-si (KR)

(73) Assignee: SAMSUNG SDI CO., LTD., Yongin-si (KR)

(21) Appl. No.: 13/671,365

(22) Filed: Nov. 7, 2012

Related U.S. Application Data
(60) Provisional application No. 61/640,566, filed on Apr. 30, 2012.

(51) Int. Cl. H01M 8/02; B01J 32/00

(52) U.S. Cl. CPC H01M 8/0271; H01M 8/0269; B01J 32/00
USPC 429/483; 429/532; 429/530; 427/113

(57) ABSTRACT

Disclosed are a support for an electrode catalyst that includes a carbon support and a crystalline carbon layer disposed on a surface of the carbon support, the crystalline carbon layer including one or more heteroatoms chemically-bound to carbon of the carbon support. A method of manufacturing the support for electrode catalyst, an electrode support, and a fuel cell including the support for an electrode catalyst are also disclosed.

### CROSS-REFERENCE TO RELATED APPLICATIONS

This application claims priority to non-provisional U.S. Application No. 61/640,566, filed Apr. 30, 2012, the contents of which are hereby incorporated by reference in their entirety.

### BACKGROUND

1. Field

A support for an electrode catalyst and a method of manufacturing the same, an electrode catalyst, and a fuel cell including the same are disclosed.

2. Description of the Related Technology

A fuel cell is a power generation system for producing electrical energy through an electrochemical redox reaction of an oxygen and hydrogen included in a hydrocarbon-based material such as methanol, ethanol, natural gas, and the like. Such a fuel cell is a clean energy source with the potential to replace devices using fossil fuels. It includes a stack composed of unit cells and being capable of producing various ranges of power. Since it has higher energy density than a small lithium battery, it is considered a more useful portable power source.

A representative example of a fuel cell includes a polymer electrolyte membrane fuel cell (PEMFC). The PEMFC includes a polymer membrane having proton exchange properties, and an anode and a cathode that sandwich and contact the polymer membrane. The anode, the polymer membrane, and the cathode form a membrane-electrode assembly. Herein, the anode and the cathode include an electrode catalyst for catalyzing a reaction. The electrode catalyst generally includes a metal catalyst such as platinum (Pt) supported by a carbon support. However, the electrode catalyst may degrade as the surface area of the metal catalyst decreases due to corrosion of the carbon support and/or aggregation of the metal catalyst upon the operation of a fuel cell.

### SUMMARY OF CERTAIN INVENTIVE ASPECTS

In one aspect, a support for an electrode catalyst capable of preventing degradation of an electrode catalyst is disclosed.

In another aspect, a method of manufacturing a support for an electrode catalyst is provided.

In another aspect, an electrode catalyst including a support for an electrode catalyst is provided.

In another aspect, an electrode for a fuel cell including an electrode catalyst having a support for an electrode catalyst is provided.

In another aspect, a membrane-electrode assembly including an electrode for a fuel cell with an electrode catalyst having a support for an electrode catalyst is provided.

In another aspect, a fuel cell including the membrane-electrode assembly is provided.

In another aspect, a support for an electrode catalyst is provided that includes a carbon support and a crystalline carbon layer disposed on the surface of the carbon support and including one or more heteroatoms chemically-bound to carbon of the carbon support.

In some embodiments, the carbon support may include carbon nanostructure, carbon black, graphite, graphene, or a combination thereof. In some embodiments, the heteroatom may include nitrogen (N), sulfur (S), or a combination thereof. In some embodiments, the crystalline carbon layer may include polyaniline, polypyrrole, polythiophene, polyacrylonitrile, or a combination thereof. In some embodiments, the crystalline carbon layer may include a nitrogen (N) doped part, and the N-doped part may include a graphitic N part, a pyridinic N part, a pyrrolic N part, an N-oxide part, or a combination thereof. In some embodiments, the N-doped part may be present in an amount of about 3 to about 20 at % based on the amount of the crystalline carbon layer. In some embodiments, the graphitic N part may be present in an amount of about 15 to about 60 at % based on the amount of the N-doped part.

In another aspect, a method of manufacturing a support for an electrode catalyst is provided. The method includes, for example, forming a carbon layer having one or more heteroatoms on a surface of a carbon support and performing heat treatment.

In some embodiments, the method may further include surface-modifying the carbon support with a conductive polymer before forming a carbon layer having a heteroatom on a surface of a carbon support. In some embodiments, the surface-modifying may be performed by polymer-wrapping with a hydrophilic conductive polymer. In some embodiments, the surface-modifying may include polymer-wrapping of polystyrene sulfonate, poly(diallyl dimethyl ammonium chloride) (PDAC), poly(allylamine hydrochloride), poly(vinylsulfonic acid) (PVS), poly(ethyleneimine) (PEI), or a combination thereof, on the surface of the carbon support. In some embodiments, the one or more heteroatoms may include nitrogen (N), sulfur (S), or a combination thereof. In some embodiments, the forming a carbon layer having one or more heteroatoms on a surface of a carbon support may be performed using polyaniline, polypyrrole, polythiophene, polyacrylonitrile, or a combination thereof. In some embodiments, the heat treatment may be performed at about 450 to about 1500° C. In some embodiments, the forming the carbon layer having the one or more heteroatoms on a surface of a carbon support may be performed using a Fe catalyst. In some embodiments, the Fe catalyst may be used in an amount of about 0.1 mole to about 6.0 moles based on about 1 mole of a monomer for forming a polymer used for forming the carbon layer having the one or more heteroatoms.

In another aspect, an electrode catalyst is provided. The electrode catalyst may include, for example, a support for an electrode catalyst of the present disclosure and a metal catalyst supported on the support.

In another aspect, an electrode for a fuel cell is provided. The electrode for a fuel cell may include, for example, an electrode substrate and an electrode catalyst of the present disclosure disposed on one side of the electrode substrate.

In another aspect, a membrane-electrode assembly for a fuel cell is provided. The membrane-electrode assembly may include, for example, an anode and a cathode facing each other and polymer electrolyte membrane interposed between the anode and the cathode. In some embodiments, at least one of the anode and cathode includes an electrode substrate and a catalyst layer disposed on one side of the electrode substrate and including an electrode catalyst of the present disclosure.

In another aspect, a fuel cell is provided. The fuel cell includes, for example, a membrane-electrode assembly of the present disclosure and a separator disposed on at least one side of the membrane-electrode assembly.

### BRIEF DESCRIPTION OF THE DRAWINGS

The accompanying drawings, together with the specification, illustrate exemplary embodiments, and, together with the description, serve to explain the principles of the present disclosure.

FIG. 1 is a schematic view showing a structure of the crystalline carbon layer.

FIG. 2 is a cross-sectional view of a membrane-electrode assembly according to one embodiment.

FIG. 3 is a graph showing a N-doping ratio and a graphite N ratio of the electrode supports according to Examples 1 to 3.

FIG. 4 is a graph showing changes of the electrochemical activation surface areas (ECSA) according to the cycle number of a platinum catalyst using the electrode supports according to Examples 1 to 3 and Comparative Example.

### DETAILED DESCRIPTION OF CERTAIN INVENTIVE EMBODIMENTS

In the following detailed description, only certain exemplary embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

A support for an electrode catalyst according to one embodiment is described below. The support for an electrode catalyst includes a carbon support and a crystalline carbon layer disposed on the surface of the carbon support. The crystalline carbon layer includes one or more heteroatoms chemically-bound to carbon of the carbon support.

The carbon support may include, for example a carbon nanostructure, carbon black, acetylene black, graphite, graphene, or a combination thereof. The carbon nanostructure may be carbon nanotube, carbon nanowire, and the like. The carbon support may have a modified surface. The surface may be modified by polymer-wrapping the carbon support with a conductive polymer. The polymer-wrapping may be performed on the surface of the carbon support while not damaging the carbon support and not affecting the damage conductivity.

The conductive polymer may include, for example, a water-soluble polymer or a polymer electrolyte, for example polystyrenesulfonate, poly(diallyl dimethyl ammonium chloride) (PDAC), poly(allylamine hydrochloride), poly(vinylsulfonic acid) (PVS), poly(ethyleneimine) (PEI), and the like. The surface-modified carbon support may be hydrophilic.

The crystalline carbon layer may include one or more heteroatoms. The one or more heteroatoms may include nitrogen (N), sulfur (S), or a combination thereof. The crystalline carbon layer may be formed by polymerizing the surface-modified carbon support with a heteroatom-containing polymer, for example, polyaniline, polypyrrole, polythiophene, polyacrylonitrile, or a combination thereof, and performing a heat treatment. Through the polymer polymerization and heat treatment, a chemical bond may be formed between a carbon of the carbon support and a heteroatom of the crystalline carbon layer, and a heteroatom doped part may be formed in the carbon support. The heteroatom doped part may be configured not only to improve an anti-corrosive property of the carbon support, but also to improve durability of an electrode catalyst by functioning as an anchoring site on the surface of the support and enhancing the bounding force between the support and the metal catalyst. Moreover, since the heteroatom doped part may be positioned evenly on the entire surface of the carbon support, dispersion of the metal catalyst may also be improved.

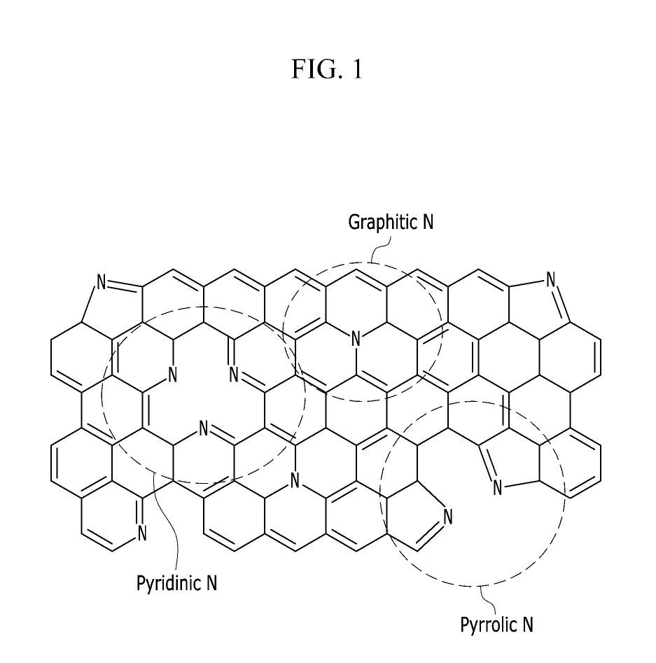

FIG. 1 is a schematic view showing a structure of the crystalline carbon layer. Referring to FIG. 1, the crystalline carbon layer is a nitrogen (N)-doped carbon layer, and the N-doped carbon layer may include a pyridinic N part represented by the following Chemical Formula 1, a graphitic N part represented by the following Chemical Formula 2, a pyrrolic N part represented by the following formula 3, and a N-oxide part.

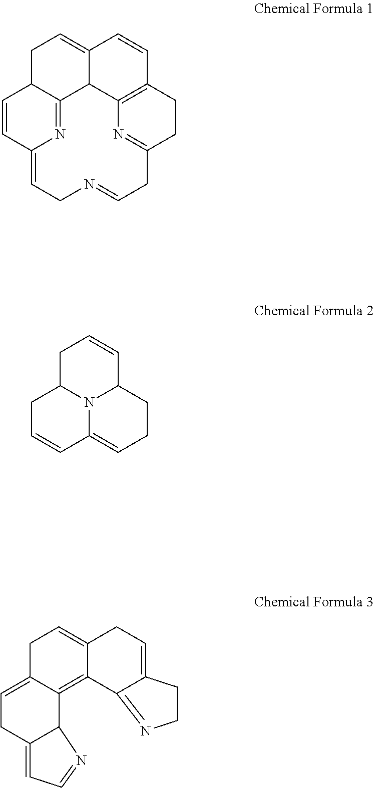 [SMILES: C1=CC2=C3N=C(C/C=N/C/C=C4/C=CC5CC=C1C3C5=N4)CC2 ; C1=CC2=CCCC3C=CCC(C1)N23 ; C1=NC2C(=C1)CC=C1CC=C3CC=C4CCN=C4C3=C12]

The N-doped part may be included in an amount of about 3 to 20 at % based on the crystalline carbon layer. For example, the N-doped part may be included in an amount greater than, less than, or any range in between about 3, 4, 5, 6, 7, 8, 9, 10, 11, 12, 13, 14, 15, 16, 17, 18, 19 and 20 at %. As the N-doped part is included within the range, the support may be secured with durability while maintaining coating uniformity of the crystalline carbon layer.

The pyridinic N part, the pyrrolic N part and the N-oxide part may be formed into a graphitic N part through a heat treatment. Among the N-doped part, the graphitic N part may be included in an amount of about 15 to about 60 at % based on the N-doped part. For example, the graphitic N part may be included in an amount greater than, less than, or any range in between about 15, 20, 25, 30, 35, 40, 45, 50, 55 and 60 at % based on the N-doped part. As the graphitic N part is included within the range, a crystalline carbon layer of a robust structure is formed so as to improve the durability of the electrode catalyst.

Hereinafter, a method of manufacturing a support for an electrode catalyst is described. The method of manufacturing a support for an electrode catalyst according to one embodiment includes surface-modifying a carbon support with a conductive polymer, forming a carbon layer having one or more heteroatoms on a surface of the surface-modified carbon support, and performing heat treatment. The surface-modifying may be performed by polymer-wrapping of the carbon support. The polymer-wrapping may be performed as a radical polymerization using a hydrophilic polymer, such as polystyrene sulfonate, or a polymer electrolyte. In some embodiments, the surface-modifying process may be omitted.

Subsequently, a carbon layer may be formed by polymerizing the polymer wrapped carbon support with a heteroatom-containing polymer, such as polyaniline, polypyrrole, polythiophene, and polyacrylonitrile in-situ. During forming of the carbon layer, a Fe catalyst may be used. The Fe catalyst may be added in a form of a Fe precursor, such as iron chloride. The Fe catalyst may increase crystallinity of the carbon layer even through a heat treatment at a relatively low temperature of lower than or equal to about 1000° C. When a heat treatment is performed at a high temperature of about 2000° C. just as in the conventional technology, the one or more heteroatoms in the inside of the carbon layer may be damaged or lost, possibly due to oxidation or reduction. On the other hand, according to the embodiment of the present disclosure, Fe catalyst is used and thus the heat treatment may be performed at a relatively low temperature, a crystalline carbon layer may be formed and simultaneously the one or more heteroatoms may be prevented from being damaged or lost.

The Fe catalyst may be used in an amount of about 0.1 mole to 6.0 moles based on 1 mole of a monomer used for forming the carbon layer having one or more heteroatoms. The monomer may include, for example aniline, pyrrole, thiophene, acrylonitrile, or a combination thereof. As the Fe catalyst is included within the range, the carbon layer having one or more heteroatoms may be uniformly formed and a high-crystalline carbon layer may be formed through a relatively low temperature heat treatment.

Subsequently, the carbon layer is subjected to heat treatment. The heat treatment may be performed in a nitrogen atmosphere, hydrogen atmosphere, argon atmosphere, or air, and it may be performed at about 450 to about 1500° C. For example, the heat treatment may be performed at any temperatures greater than, less than, or any range in between about 450, 500, 550, 600, 650, 700, 750, 800, 850, 900, 950, 1000, 1050, 1100, 1150, 1200, 1250, 1300, 1350, 1400, 1450 and 1500° C. The heat treatment may be performed once or more. For example, a primary heat treatment may be performed at about 450 to about 1000° C. and then a secondary heat treatment may be performed at about 700 to about 1500° C. The high crystalline carbon layer may be formed through the primary and secondary heat treatments.

Herein, in the heat treatment process of the carbon layer, an acid leaching process may be further performed to remove the remaining Fe precursor after the primary heat treatment. The acid leaching process may be performed at a temperature of about 60 to about 90° C. for about 1 hour to about 6 hours by using such a solution as 0.5M to 2.6M H₂SO₄ solution. For example, the acid leaching process may be performed at any range of temperatures between about 60, 65, 70, 75, 80, 85 and 90° C. at any time or range of time between about 1, 2, 3, 4, 5 and 6 hours using about 0.5M to about 2.6M H₂SO₄ solution.

Through the heat treatment, the carbon layer may be crystallized to provide a crystalline carbon layer.

The support for an electrode catalyst may be applicable to an electrode catalyst for a fuel cell. The electrode catalyst for a fuel cell according to one embodiment includes the above-described support for an electrode catalyst and a metal catalyst supported on the support.

The metal catalyst helps hydrogen oxidation and oxygen reduction reactions in a fuel cell, and may include, for example platinum, ruthenium, osmium, a platinum-ruthenium alloy, a platinum-osmium alloy, a platinum-palladium alloy, a platinum-M alloy (M is at least one transition element selected from Ga, Ti, V, Cr, Mn, Fe, Co, Ni, Cu, and Zn), and particularly at least one catalyst selected from platinum, ruthenium, osmium, a platinum-ruthenium alloy, a platinum-osmium alloy, a platinum-palladium alloy, a platinum-cobalt alloy, or a platinum-nickel alloy is preferable.

The metal catalyst may be used by being supported on the support, and since the process of supporting the metal catalyst with a support is widely known to those skilled in the art, further description on it is omitted herein.

Hereinafter, a membrane-electrode assembly according to one embodiment is provided.

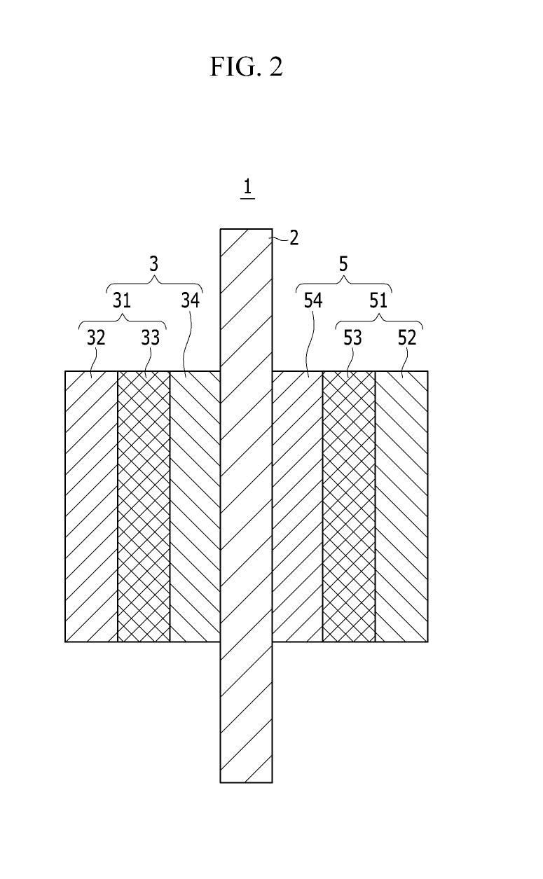

FIG. 2 is a cross-sectional view of a membrane-electrode assembly according to one embodiment. The membrane-electrode assembly 1 includes an anode 3 and a cathode 5 facing each other and a polymer electrolyte membrane 2 interposed between the anode 3 and cathode 5. The anode 3 and cathode 5 includes catalyst layers 34 and 54 and diffusion layers 31 and 51, respectively. The diffusion layers 31 and 51, respectively, include electrode substrates 32 and 52 supporting catalyst layers 34 and 54, and microporous layers 33 and 53 interposed between the catalyst layers 34 and 54 and the electrode substrates 32 and 52, which may be configured to improve a gas diffusion effect.

In the catalyst layer 34 of the anode 3, oxidation reactions of a fuel may occur. In the catalyst layer 54 of the cathode 5, reduction reactions of an oxidizing agent may occur. The catalyst layers 34 and 54 include the electrode catalyst described above.

The polymer electrolyte membrane 2 may be formed of a polymer having excellent proton conductivity. The polymer electrolyte membrane 2 may be configured to perform ion exchange functions to transfer protons produced in the catalyst layer 34 of the anode 3 to the catalyst layer 54 of the cathode 5. Such a polymer may include, for example a perfluoro-based polymer, a benzimidazole-based polymer, a polyimide-based polymer, a polyetherimide-based polymer, a polyphenylenesulfide-based polymer, a polysulfone-based polymer, a polyethersulfone-based polymer, a polyetherketone-based polymer, a polyether-etherketone-based polymer, a polyphenylquinoxaline-based polymer, and the like, but is not limited thereto. Specific examples of the polymer may include poly(perfluorosulfonic acid), poly(perfluorocarboxylic acid), a sulfonic acid group-containing copolymer of tetrafluoro ethylene and fluorovinylether, defluorinated sulfide polyetherketone, aryl ketone, or polybenzimidazole such as poly(2,2′-(m-phenylene)-5,5′-bibenzimidazole), poly(2,5-benzimidazole), and the like, but are not limited thereto.

In a fuel cell, the cathode and the anode are not necessarily distinguished by their materials, but instead may be distinguished by their functions. The electrodes for a fuel cell may include an anode configured for hydrogen oxidation and a cathode configured for oxygen reduction. In short, in the fuel cell, electricity may be produced by supplying hydrogen or fuel to the anode, supplying oxygen to the cathode and causing an electrochemical reaction between the anode and the cathode. An oxidation reaction of hydrogen or organic fuel occurs in the anode, and a reduction reaction of oxygen occurs in the cathode so as to cause a voltage difference between the two electrodes.

The fuel cell according to an embodiment includes the membrane-electrode assembly and a separator disposed on at least one side of the membrane-electrode assembly. The separator includes a flow path configured to provide a gas by contacting either the anode or the cathode (or both) of the membrane-electrode assembly.

The following examples illustrate embodiments of the present disclosure in more detail. However, it is understood that the present disclosure is not limited by these examples.

### Example 1

Carbon black was treated with ultrasonic wave in deionized water for 20 minutes to obtain a carbon suspension. Sodium 4-styrenesulfonate hydrate (C₈H₇SO₃Na. xH₂O) and potassium persulfate were added in a small amount to the carbon suspension and agitated at 65° C. for 24 hours for radical polymerization

After the polymerization, the resultant solution was filtrated and washed with deionized water and methanol several times. Subsequently, carbon black polymer-wrapped with polystyrene sulfonic acid (PSA) was obtained by performing a vacuum-drying at 70° C.

Subsequently, a suspension was obtained by treating the polymer-wrapped carbon black with ultrasonic wave in deionized water. Pyrrole was put into the polymer-wrapped carbon black suspension and agitated for 30 minutes. Several drops of ammonium persulfate ((NH₄)₂S₂O₈) were added thereto and the resultant solution was agitated in a nitrogen atmosphere at 5° C. for 24 hours for chemical polymerization. After the polymerization was completed, the resultant solution was filtrated and washed with deionized water and methanol several times. Subsequently, a polypyrrole (PPy) carbon layer was formed by performing a vacuum-drying at 70° C.

Subsequently, the polypyrrole (PPy) carbon layer was heat-treated at 800° C. to form a crystalline carbon layer. This process resulted in a carbon support coated with a crystalline carbon layer.

### Example 2

Carbon black was treated with ultrasonic wave in deionized water for 20 minutes to obtain a carbon suspension. Aniline was added to the carbon suspension and agitated for 30 minutes. FeCl₃ aqueous solution (3 mole ratio based on the aniline) was added thereto and then ammonium persulfate ((NH₄)₂S₂O₈) was added thereto and agitated in a nitrogen atmosphere at 5° C. for 24 hours for chemical polymerization. After the polymerization was completed, the resultant solution was filtrated and washed with deionized water and methanol several times. Subsequently, the resultant was performed a vacuum-drying at 70° C. to form a polyaniline carbon layer.

Subsequently, the polyaniline carbon layer was performed a primary heat treatment at 700° C. to crystallize the carbon layer. After the primary heat treatment, Fe remaining after an acid leaching process was removed and then performed a secondary heat treatment at 700° C. to prepare a carbon support coated with a crystalline carbon layer.

### Example 3

A carbon support coated with a crystalline carbon layer was prepared according to the same method as Example 2, except that the primary heat treatment process was performed at 900° C. and the secondary heat treatment process was performed at 900° C.

### COMPARATIVE EXAMPLE

Carbon black without a carbon layer was prepared as an electrode support.

### Evaluation 1

The N-doping ratio and the graphitic N ratio of the carbon supports according to Examples 1 to 3 were measured. The N-doping ratio and the graphitic N ratio were analyzed using an x-ray photoelectron spectroscopy (XPS).

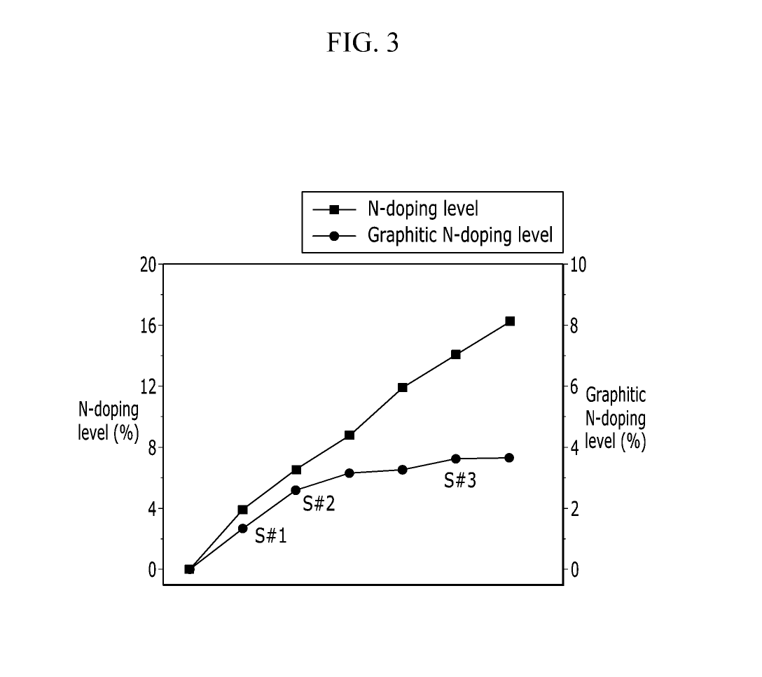

The results are shown in FIG. 3. FIG. 3 is a graph showing a N-doping ratio and a graphitic N ratio of the electrode supports according to Examples 1 to 3. Referring to FIG. 3, it may be seen that the electrode supports according to Examples 1 to 3 included the N-doped part at a ratio of about 3 to 20 at % and the graphitic N part at a ratio of about 0.45 to about 12 at % based on the carbon layer. The graphite N ratio corresponded to about 15% to about 60% based on the N-doped part.

### Evaluation 2

Crystallinity of the carbon layer in the carbon supports according to Examples 1 to 3 was confirmed. The crystallinity of the carbon layer may be confirmed by Raman spectrum, specifically, from the ratio (I_{D}/I_{G}) of the intensity (I_{D}) at 1300 cm⁻¹ and the intensity (I_{G}) at 1550 cm⁻¹. The results are as shown in Table 1.

TABLE 1

| | I_{D}/I_{G} |
|---|---|
| Example 1 | 1.06 |
| Example 2 | 0.94 |
| Example 3 | 0.83 |
| Comparative Example | 1.80 |

It may be seen from Table 1 that since the electrode supports according to Examples 1 to 3 had the ratio (I_{D}/I_{G}) of about 0.8 to 1.2, the electrode supports according to Examples 1 to 3 had high crystallinity.

### Evaluation 3

A platinum catalyst was prepared by supporting 40 wt % platinum (Pt) in the carbon supports according to Examples 1 to 3 and Comparative Example. Electrochemical surface area (ECSA) according to the cycle number of the platinum catalyst was evaluated.

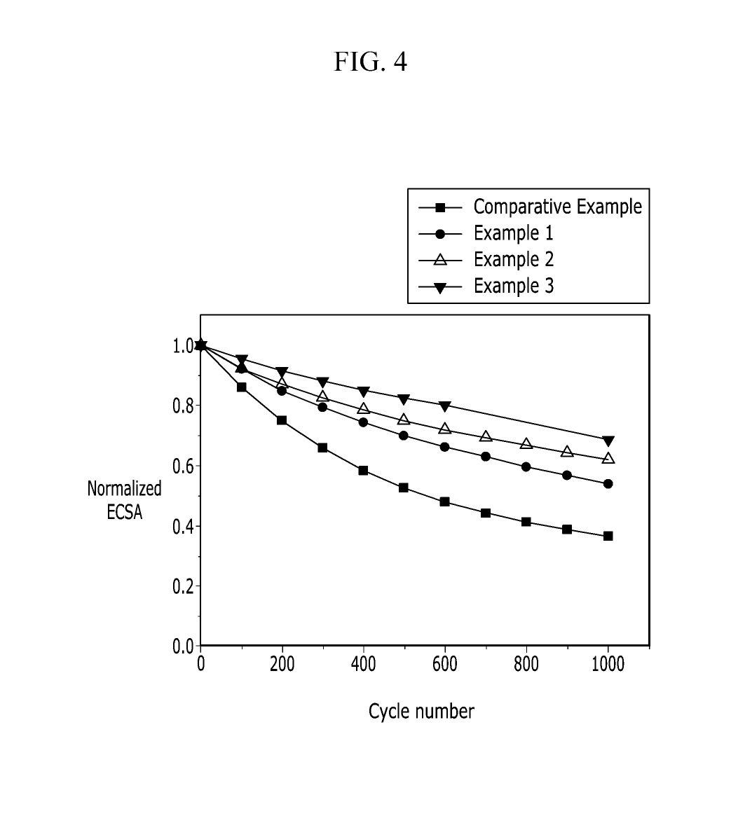

The results are shown in FIG. 4. FIG. 4 is a graph showing changes of electrochemical activation surface areas (ECSA) according to the cycle number of a platinum catalyst using the electrode supports according to Examples 1 to 3 and the Comparative Example. Referring to FIG. 4, it may be seen that the platinum catalysts using the carbon supports according to Examples 1 to 3 had a low decrement rate of the electrochemical surface area (ECSA), compared with the platinum support using the carbon support according to the Comparative Example. It may be seen from the low decrement rate that the carbon supports according to Examples 1 to 3 did not degrade to the same extent as the carbon support according to the Comparative Example.

While this invention has been described in connection with what is presently considered to be practical exemplary embodiments, it will be appreciated by those skilled in the art that various modifications and changes may be made without departing from the scope of the present disclosure. It will also be appreciated by those of skill in the art that parts mixed with one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A support for an electrode catalyst, comprising:
a carbon support; and
a crystalline carbon layer disposed on a surface of the carbon support, the crystalline carbon layer including one or more heteroatoms chemically-bound to carbon of the carbon support.

2. The support of claim 1, wherein the one or more heteroatoms are selected from the group consisting of include nitrogen (N), sulfur (S), or a combination thereof.

3. The support of claim 1, wherein the carbon support is formed of a material selected from the group consisting of carbon nanostructure, carbon black, graphite, graphene, and a combination thereof.

4. The support of claim 1, wherein the crystalline carbon layer is formed of a material selected from the group consisting of polyaniline, polypyrrole, polythiophene, polyacrylonitrile, and a combination thereof.

5. The support of claim 1, wherein the crystalline carbon layer further includes a nitrogen (N)-doped part, the N-doped part formed of a material selected from the group consisting of pyridinic nitrogen, pyrrolic nitrogen, graphitic nitrogen, a nitrogen oxide part, and a combination thereof.

6. The support of claim 5, wherein the N-doped part includes about 3 at % to about 20 at % of the crystalline carbon layer.

7. The support of claim 5, wherein the graphitic N includes about 15 at % to about 60 at % by weight of the N-doped part.

8. The support of claim 1, wherein the ratio (I_{D}/I_{G}) of the intensity (I_{D}) at 1300 cm⁻¹ and the intensity (I_{G}) at 1550 cm⁻¹ in the Raman spectrum of the crystalline carbon layer is between about 0.8 to about 1.2.

9. A method of manufacturing a support for an electrode catalyst, comprising:
forming a carbon layer including one or more heteroatoms on a surface of a carbon support; and
performing heat treatment on the carbon layer to form a crystalline carbon layer on the surface of the carbon support, the crystalline carbon layer including the one or more heteroatoms chemically-bound to carbon atoms of the carbon support.

10. The method of claim 9 further comprising surface-modifying the carbon support with a conductive polymer before forming the carbon layer.

11. The method of claim 10, wherein the surface-modifying is performed by polymer-wrapping with a hydrophilic conductive polymer.

12. The method of claim 10, wherein the surface-modifying includes polymer-wrapping of polystyrene sulfonate, poly(diallyl dimethyl ammonium chloride) (PDAC), poly(allylamine hydrochloride), poly(vinylsulfonic acid) (PVS), poly(ethyleneimine) (PEI), or a combination thereof, on the surface of the carbon support.

13. The method of claim 9, wherein the one or more heteroatoms include nitrogen (N), sulfur (S), or a combination thereof.

14. The method of claim 9, wherein the forming the carbon layer comprises using polyaniline, polypyrrole, polythiophene, polyacrylonitrile, or a combination thereof.

15. The method of claim 9, wherein the heat treatment is performed at about 450° C. to about 1500° C.

16. The method of claim 9, wherein the forming the carbon layer comprises using a Fe catalyst.

17. The method of claim 16, wherein the Fe catalyst is present in an amount of about 0.1 mole to about 6.0 moles based on 1 mole of a monomer for forming a polymer used for forming the carbon layer.

18. An electrode catalyst, comprising the support of claim 1 and a metal catalyst.

19. A fuel cell, comprising:
a membrane-electrode assembly including an anode and a cathode facing each other, and a polymer electrolyte membrane interposed between the anode and the cathode, at least one of the anode and the cathode including an electrode substrate and the electrode catalyst of claim 18 disposed on one side of the electrode substrate; and
a separator disposed on at least one side of the membrane-electrode assembly.
